(19) United States
(12) Patent Application Publication
(10) Pub. No.: US 2012/0024251 A1
(43) Pub. Date: Feb. 2, 2012

(54) Gas engine having a laser ignition device

(76) Inventors: Martin Weinrotter, Stuttgart-Botnang (DE); Werner Herden, Gerlingen (DE); Pascal Woerner, Stuttgart (DE); Juergen Raimann, Weil Der Stadt (DE)

(21) Appl. No.: 13/258,833

(22) PCT Filed: May 10, 2010
(86) PCT No.: PCT/EP10/56338

§ 371 Date: Sep. 22, 2011

(30) Foreign Application Priority Data
May 13, 2009 (DE) 10 2009 003 075.1

(51) Int. Cl. F02P 23/04

(52) U.S. Cl. 123/143 B

(57) ABSTRACT

An internal combustion engine, in particular a gas engine, is described, which is equipped with a laser ignition device, and the combustion chamber has an essentially point-symmetrical shape at the ignition point.

### FIELD OF THE INVENTION

The present invention relates to an internal combustion engine equipped with a laser ignition device, in particular a gas engine.

### BACKGROUND INFORMATION

German patent document DE 10 2004 001 554 A1 discusses a laser ignition device for igniting an air-fuel mixture in an internal combustion engine, an ignition laser of the laser ignition device protruding into a combustion chamber of the internal combustion engine. The ignition laser is supplied optically by a pumped light source via an optical fiber.

Large-scale gas engines are usually operated near the lean limit of a fuel-air mixture in order to achieve a good efficiency. A stable flame core must be formed during ignition, so that the fuel-air mixture in the combustion chamber may be burned afterward as rapidly as possible. Specifically in the case of gas engines operated in the extremely lean range, it is of utmost importance to reduce the combustion time and thereby increase engine efficiency. The combustion time is defined as the period of time within which between 10% and 90% of the energy conversion takes place.

In the case of conventional high voltage ignitions using spark plugs, the ignition spot is necessarily close to the roof of the combustion chamber, so that the flame propagates into the combustion chamber in the direction of the piston bottom approximately hemispherically. The combustion time is therefore comparatively long. To counteract this long combustion time, internal combustion engines today are often designed as short-stroke engines, i.e., having a bore diameter larger than the piston stroke length. The flame pathways in the direction of the piston are shortened in this way. To nevertheless achieve rapid and thorough combustion of the mixture, a high velocity of flow and consequently a high turbulence must prevail in the combustion chamber. In traditional internal combustion engines, this is achieved by swirl flows and quench flows.

To generate these flows and the resulting turbulence, substantial charge cycle losses occur and/or unfavorable chamber geometries in which the ratio between the surface area and the volume is great are required, so that high wall heat losses occur. The charge cycle losses as well as the wall heat losses reduce the efficiency of the internal combustion engine.

### SUMMARY OF THE INVENTION

An object of the exemplary embodiments and/or exemplary methods of the present invention is to improve upon an internal combustion engine having a laser ignition device, so that a reliable and low-emission combustion is ensured at various operating points, in particular even with a lean fuel-air mixture, while ensuring a very good efficiency at the same time.

This object may be achieved by an internal combustion engine having an ignition laser with the features described herein. Features important for the exemplary embodiments and/or exemplary methods of the present invention are also to be found in the following description and in the drawings, where the features either alone or in various combinations may be important for the present invention without any explicit reference thereto. Advantageous refinements are found in the subclaims.

According to the exemplary embodiments and/or exemplary methods of the present invention, it is provided that the combustion chamber is designed to be spheroidal.

This makes it possible for the flame front to propagate in the form of a sphere in all directions of the chamber, significantly shortening the flame paths and the compression time. Consequently the efficiency of the internal combustion engine also increases.

Since it is provided, according to the exemplary embodiments and/or exemplary methods of the present invention that the combustion chamber is to be designed to be spheroidal, in particular spherical, and in particular point-symmetrical with the ignition spot of the ignition laser at the point in time of ignition of the fuel-air mixture in the combustion chamber, the travel times of the flame front until reaching the combustion chamber wall are almost of the same short length everywhere. The result is a very compact combustion chamber shape and a favorable surface/volume ratio of the combustion chamber. The wall heat losses are therefore reduced and the efficiency of the internal combustion engine is further increased. The risk of so-called knocking combustion is also reduced and the internal combustion engine according to the present invention often manages without swirl flows or quench flows.

Due to the oscillating movement of the piston, it is self-evident that the shape of the combustion chamber naturally depends on the position of the crankshaft or the position of the piston in the cylinder. Therefore, in the internal combustion engine according to the present invention, emphasis is placed on the shape of the combustion chamber at the start of ignition. In other words, this ensures that even during the subsequent very short combustion time, the combustion chamber will have a favorable geometry for the combustion process.

The combustion chamber has a spheroidal geometry in particular when the combustion chamber encloses a spherical volume, which constitutes no less than 50%, in particular no less than 67%, in particular no less than 80% of the total volume of the combustion chamber.

A spheroidal geometry of the combustion chamber is also obtained in particular when the combustion chamber has a total surface area and a total volume, the total surface area being no greater than 1.5 times, in particular no greater than 1.25 times, in particular no greater than 1.15 times of the surface area of a sphere whose volume is equal to the total volume of the combustion chamber.

An advantageous embodiment of the present invention provides that a combustion chamber roof formed in the cylinder head and a piston bottom of the piston have the same shape.

Advantageous embodiments of the present invention provide that the combustion chamber roof and the piston bottom are planar, frustoconical and/or dome-shaped. The advantages according to the exemplary embodiments and/or exemplary methods of the present invention are easily implemented by using these geometries.

It has additionally proven advantageous if, at the ignition point, the maximum distance between the combustion chamber roof and the piston bottom corresponds approximately to the diameter of the piston. This ensures a very compact combustion chamber shape.

In an additional advantageous embodiment of the present invention, it is provided that the ignition laser has an antechamber having at least one opening, which may be at least one borehole, and that one ignition spot of the ignition laser is located in the antechamber.

It is additionally provided that the antechamber has openings, which may be boreholes, which are directed into the combustion chamber. This achieves the result that the fuel-air mixture ignited in the antechamber passes through the opening in the form of an ignition flare into the combustion chamber according to the exemplary embodiments and/or exemplary methods of the present invention, where it ensures a rapid burn-up of the fuel mixture in the combustion chamber. Here again, the geometries according to the exemplary embodiments and/or exemplary methods of the present invention of the combustion chamber are advantageous.

Additional advantages and advantageous embodiments of the present invention are shown in the following drawings and described in the description and the patent claims. All the features disclosed in the drawings, the description and the patent claims may be essential to the present invention, either individually or in any combination with one another.

Exemplary embodiments of the present invention are explained as an example below on the basis of the figures.

### BRIEF DESCRIPTION OF THE DRAWINGS

FIG. 1a shows a schematic diagram of an internal combustion engine having a laser-based ignition device.

FIG. 1b shows a schematic representation of the ignition device from FIG. 1a.

FIG. 2 shows a detailed representation of an internal combustion engine according to the present invention.

FIG. 3 shows another detailed representation of an internal combustion engine according to the present invention.

FIG. 4 shows another detailed representation of an internal combustion engine according to the present invention.

### DETAILED DESCRIPTION

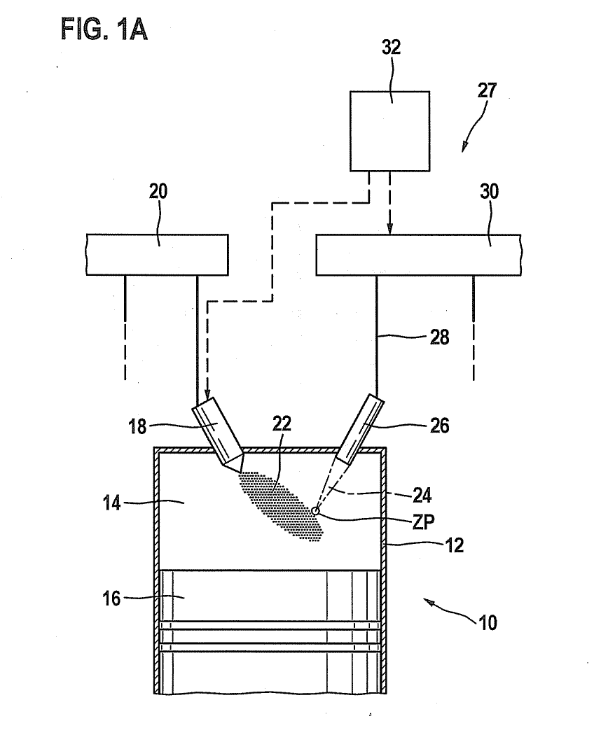

An internal combustion engine is labeled with reference numeral 10 on the whole in FIG. 1a. It may be used to drive a motor vehicle (not shown). Internal combustion engine 10 usually has several cylinders, only one of which is labeled with reference numeral 12 in FIG. 1a. A combustion chamber 14 of cylinder 12 is delimited by a piston 16. Fuel enters combustion chamber 14 directly through an injector 18, which is connected to a fuel pressure accumulator 20, also known as a rail. Alternatively, the fuel-air mixture may also be formed outside of combustion chamber 14, for example, in an intake manifold.

Fuel-air mixture 22 in combustion chamber 14 is ignited by a laser pulse 24 emitted into combustion chamber 14 by a laser ignition device 27, which includes an ignition laser 26. The ignition in combustion chamber 14 may also be prepared in an antechamber (not shown in FIG. 1) situated upstream from the combustion chamber. Ignition laser 26 is supplied via a fiber optic light guide 28 with a pumped light, which is supplied by a pumped light source 30. Pumped light source 30 is controlled by a control unit 32, which is also able to trigger injector 18.

As shown in FIG. 1b, pumped light source 30 has multiple fiber optic light guides 28 for various ignition lasers 26, each of which is assigned to one cylinder 12 of internal combustion engine 10. For this purpose, pumped light source 30 has multiple individual pumped laser light sources 34, which are connected to a pulsed current supply 36. Due to the presence of multiple individual pumped laser light sources 34, the pumped light is distributed, so to speak, “latently” to the various laser devices 26, so that no optical distributors or the like between pumped light source 30 and ignition lasers 26 are necessary.

Ignition laser 26 has, for example, a laser-active solid-state body 44 having a passive Q-switch 46, which together with an input mirror 42 and an output mirror 48 forms an optical resonator. Under the action of the pumped light generated by pumped light source 30, ignition laser 26 generates in a known manner a laser pulse 24, which is focused by a focusing lens 52 on an ignition spot ZP situated in combustion chamber 14 (or in an antechamber, not shown here). The components in housing 38 of ignition laser 26 are separated from combustion chamber 14 by an exit window 58 for laser beams 24.

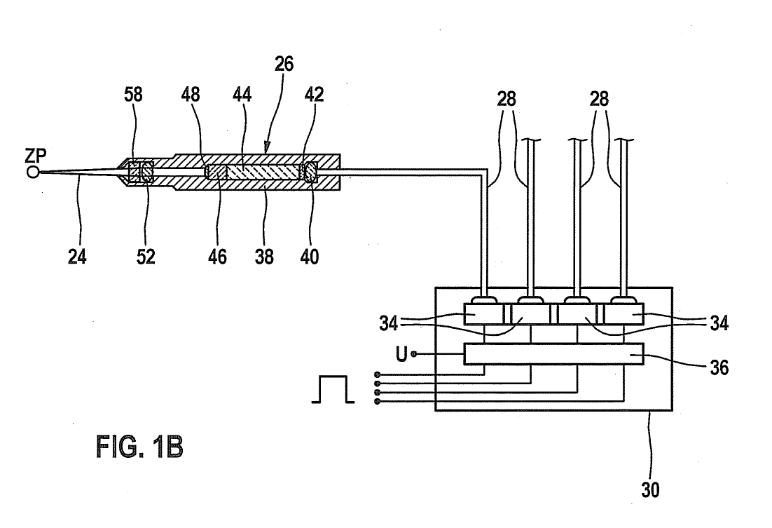

A cylinder head 17 having indicated charge cycle valves 19 and a screwed-in ignition laser 27 is apparent in FIG. 2. Ignition spot ZP of ignition laser 27 lies in the center of combustion chamber 14 at the ignition point.

The possible spherical propagation of the flame front in the internal combustion engine according to the present invention is indicated in FIG. 2 by dash-dot rings. Since the flame front in FIG. 2 has already reached one-third of combustion chamber 14, it thus illustrates a situation in which piston bottom 15 has moved further in the direction of top dead center TDC, i.e., in the direction of combustion chamber roof 69 in comparison with the ignition point. The position of piston bottom 15 at the ignition point is indicated by a dashed line 15′. In this position, combustion chamber 14 is spheroidal and also point-symmetrical with respect to ignition spot ZP. Thus a very short combustion time is implemented, and at the same time a very favorable ratio between the surface area and volume of the combustion chamber is achieved.

The height of the combustion chamber at the ignition point is indicated by reference letter H in FIG. 2. In the exemplary embodiment shown in FIG. 2, a borehole diameter B of cylinder 12 and of piston 16 is greater than height H of the combustion chamber at the point in ignition time. It is now also possible according to the present invention to reduce diameter B of piston 16 while at the same time increasing the stroke of the piston. The internal combustion engine would thus have a longer stroke and the combustion chamber geometry would be even more compact.

In the exemplary embodiment according to FIG. 2, combustion chamber roof 69 and piston bottom 15 are both planar. This nevertheless yields a very short combustion time because the distance between ignition spot ZP and the walls (in particular the cylinder borehole of cylinder 12, combustion chamber roof 69 and piston bottom 15) delimiting combustion chamber 14 is very short.

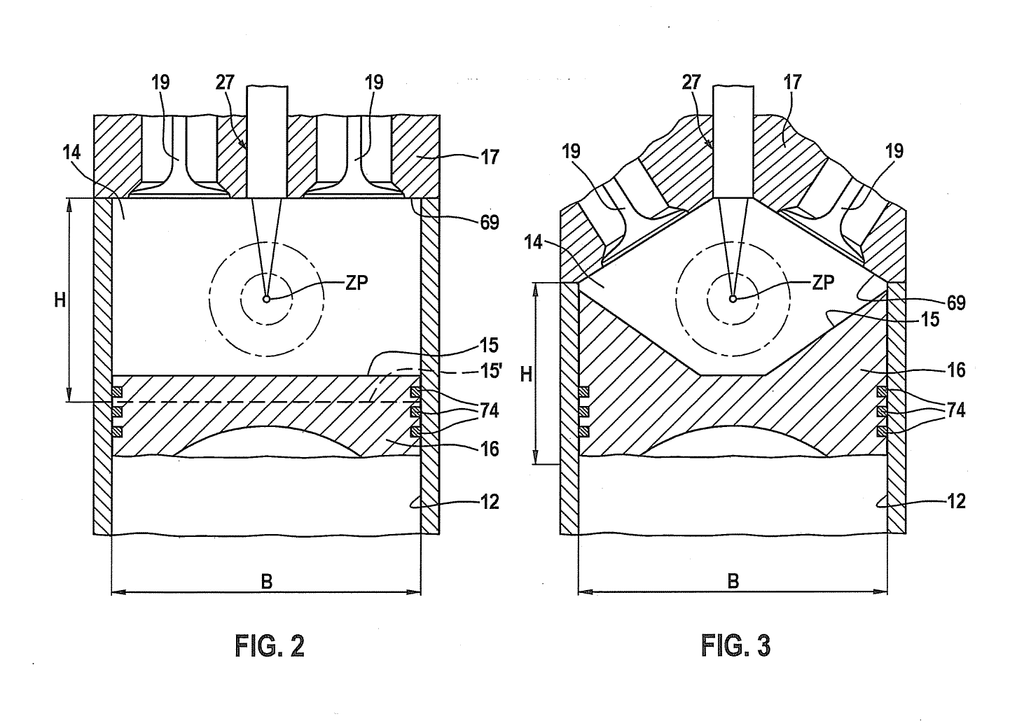

FIG. 3 shows a further optimized exemplary embodiment of an internal combustion engine according to the present invention. In this exemplary embodiment, combustion chamber roof 69 and piston bottom 15 both have a frustoconical design, resulting in a diamond-shaped combustion chamber 14 in the longitudinal section, which comes even closer to the ideal shape of a spherical combustion chamber. With this combustion chamber geometry, charge cycle valves 19 and thus the inlet and outlet channels (without reference numerals) may be integrated very favorably and easily into the combustion chamber geometry.

At the point in time illustrated in FIG. 3, piston 16 is at the top dead center and combustion chamber 14 is delimited almost exclusively by combustion chamber roof 69 and piston bottom 15. Only a very narrow ring of cylinder 12 also delimits combustion chamber 14 between cylinder head 17 and piston bottom 15. The heat dissipation over the cylinder wall is therefore very minor. Here again, it is clear that the flame front propagating from ignition spot ZP travels very short distances and hits combustion chamber roof 69 as well as piston bottom 15 almost simultaneously. The advantages according to the present invention may also be implemented in this way.

It is, of course, also possible to design a combustion chamber roof 69 and a piston bottom 15 in the form of a hemisphere or a spherical calotte, so that an even closer approach to the ideal shape of a complete spheroidal combustion chamber is achieved. This exemplary embodiment is not shown.

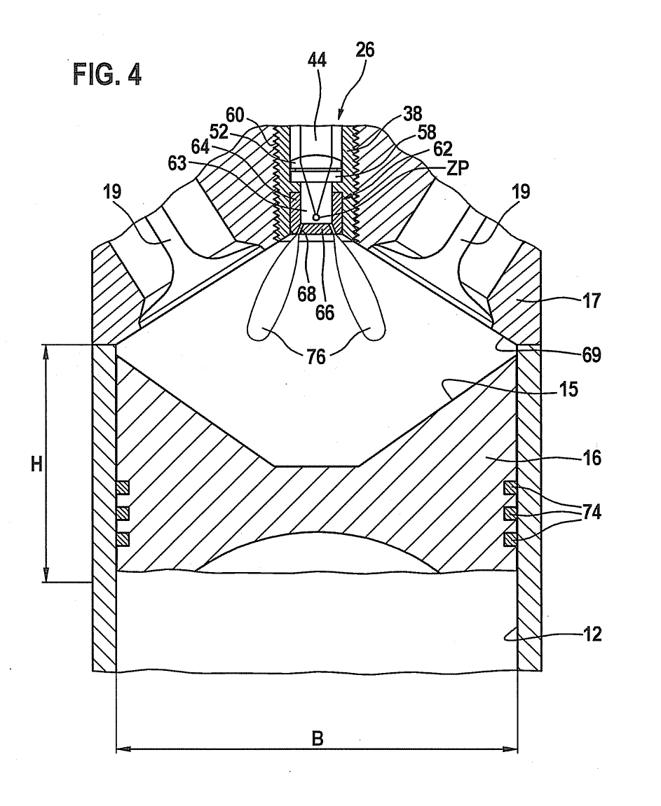

In the exemplary embodiment according to FIG. 4, ignition spot ZP is placed in antechamber 63 of ignition laser 26. Laser ignition device 27 shown in FIG. 4 includes ignition laser 26 having housing 38, exit window 58 for laser beams 24 and focusing lens 52. Housing 38 of ignition laser 26 is screwed by a thread 60 into an opening provided for this purpose in a cylinder head of internal combustion engine 10. Alternative fastening options using a bayonet closure or a clamping claw, for example, are also possible. Ignition spot ZP of ignition laser 26 is in a cylindrical insert 62, which is integrated into and/or installed in housing 38 of ignition laser 26 in FIG. 2. Insert 62 is thus an integral component of ignition laser 26.

Insert 62 delimits an antechamber 63 of combustion chamber 14. Insert 62 includes a cylindrical lateral area 64, which is closed at the bottom by a bottom plate 66 in FIG. 4, bottom plate 66 having boreholes 68 running obliquely downward in an edge area. Bottom plate 66 forms a planar connection to the area of the cylinder head facing combustion chamber 14. Combustion chamber 14 is formed partially by a frustoconical combustion chamber roof 69 in the cylinder head and a piston bottom 15 of piston 16 of internal combustion engine 10. Piston 16 is guided in cylinder 12 and has piston rings 74 on its circumference.

When the fuel-air mixture in antechamber 63 is ignited, combustion begins there and ignition flares 76 of the fuel-air mixture, which is already burning, are blasted into the combustion chamber through boreholes 68. These ignition flares ensure rapid and thorough combustion of the fuel-air mixture in combustion chamber 14 according to the present invention. Since it is possible to provide multiple boreholes 68, including those running obliquely, the ignition flares may be aligned in such a way that the combustion paths, starting from ignition flares 76 up to the outermost corners of the combustion chamber, are as short as possible. For this reason, boreholes 68 are pivoted outward at an angle with respect to the longitudinal axis of cylinder 12.

It is of course also possible to further optimize the combustion performance of the internal combustion engine via this angle and the number of boreholes 68. Here again, it is important that at the point in time when ignition flares 76 enter combustion chamber 14 from antechamber 63, combustion chamber 14 has a spheroidal shape.

Laser ignition device 27 functions as follows: Ignition laser 26 sends a laser pulse 24, which is focused in insert 62 at ignition spot ZP close to bottom plate 66. An ignitable air-fuel mixture, which is ignited at ignition spot ZP, is present in antechamber 63 as well as in combustion chamber 14. Therefore, a stable flame core, capable of igniting the air-fuel mixture in combustion chamber 14, is formed in antechamber 63.

The flame core therefore escapes in the form of flares 76 through boreholes 68. The direction of outflow and the shape of the flares 76 are determined by the design of boreholes 68 and are adapted to the shape of combustion chamber 14. Flares 76 may be aligned in such a way that flares 76 are able to propagate in the largest possible area of combustion chamber 14. In the determination of the desired direction and size of flares 76, the flow conditions in combustion chamber 14 are also taken into account. The larger the end face 72 of piston 16, the greater are also the so-called quench flows and swirl flows 80 in combustion chamber 14 when the piston is near top dead center TDC. In order to take this into account, suitably aligned boreholes 68 are required, depending on the design of combustion chamber 14 and trough 15 in bottom plate 66 and/or lateral area 64 of ignition laser 26 or of insert 62. This then permits rapid combustion of the charge in combustion chamber 14.

Since insert 62 may also be designed as a separate component, insert 62 may be selected or exchanged, depending on the design of combustion chamber 14 in internal combustion engine 10. Insert 62 may thus be exchangeable, which makes it possible to adapt ignition laser 26 to different use conditions by replacing insert 62.

1-11. (canceled)

12. An internal combustion engine, comprising:
at least one cylinder;
a piston; and
a cylinder head, wherein the cylinder and the piston delimit a combustion chamber, having a laser ignition device, including an ignition laser, and wherein the combustion chamber is spheroidal at the ignition point.

13. The internal combustion engine of claim 12, wherein the combustion chamber has a spherical volume at the ignition point, which constitutes no less than 50% of the total volume of the combustion chamber.

14. The internal combustion engine of claim 12, wherein the combustion chamber has a total surface area and a total volume at the ignition point, the total surface area being no greater than 1.5 times of the surface area of a sphere, whose volume is equal to the total volume of the combustion chamber.

15. The internal combustion engine of claim 12, wherein a combustion chamber roof formed in the cylinder head and a piston bottom of the piston have the same or approximately the same shape.

16. The internal combustion engine of claim 12, wherein a combustion chamber roof formed in the cylinder head and a piston bottom of the piston are planar.

17. The internal combustion engine of claim 12, wherein a combustion chamber roof formed in the cylinder head and a piston bottom of the piston are frustoconical.

18. The internal combustion engine of claim 12, wherein a combustion chamber roof is formed in the cylinder head, and the piston has a piston bottom, and, at the ignition point, the maximum distance between the combustion chamber roof and the piston bottom corresponds approximately to the diameter of the piston.

19. The internal combustion engine of claim 12, wherein the ignition point is in a range between 30° before TDC and 5° before TDC.

20. The internal combustion engine of claim 12, wherein an ignition spot of the ignition laser is in the center of volume at the ignition point or is a distance of less than 20% of the greatest extent of the combustion chamber from the center of volume of the combustion chamber.

21. The internal combustion engine of claim 12, wherein an ignition spot of the ignition laser is in the center of volume at the ignition point or is a distance of less than 10% of the greatest extent of the combustion chamber from the center of volume of the combustion chamber.

22. The internal combustion engine of claim 12, wherein the ignition laser has an antechamber having at least one opening, preferably at least one borehole, and an ignition spot of the ignition laser is situated in the antechamber.

23. The internal combustion engine of claim 12, wherein the combustion chamber is essentially point-symmetrical at the ignition point.

24. The internal combustion engine of claim 12, wherein the combustion chamber has a spherical volume at the ignition point, which constitutes no less than 67% of the total volume of the combustion chamber.

25. The internal combustion engine of claim 12, wherein the combustion chamber has a spherical volume at the ignition point, which constitutes no less than 80% of the total volume of the combustion chamber.

26. The internal combustion engine of claim 12, wherein the combustion chamber has a total surface area and a total volume at the ignition point, the total surface area being no greater than 1.25 times of the surface area of a sphere, whose volume is equal to the total volume of the combustion chamber.

27. The internal combustion engine of claim 12, wherein the combustion chamber has a total surface area and a total volume at the ignition point, the total surface area being no greater than 1.15 times of the surface area of a sphere, whose volume is equal to the total volume of the combustion chamber.
